(19) United States
(12) Patent Application Publication
(10) Pub. No.: US 2009/0303264 A1
(43) Pub. Date: Dec. 10, 2009

(54) LIQUID CRYSTAL DRIVING DEVICE

(75) Inventors: Goki TOSHIMA, Yokohama (JP); Yasuyuki KUDO, Tokyo (JP); Yoshiki KUROKAWA, Tokyo (JP); Akihito AKAI, Yokohama (JP); Kazuki HOMMA, Kodaira (JP)

Correspondence Address: MATTINGLY & MALUR, P.C., 1800 DIAGONAL ROAD, SUITE 370, ALEXANDRIA, VA, 22314, US

(73) Assignee: RENESAS TECHNOLOGY CORP., Tokyo (JP)

(21) Appl. No.: 12/470,526

(22) Filed: May 22, 2009

(30) Foreign Application Priority Data
Jun. 4, 2008 (JP) 2008-146458

(51) Int. Cl. G09G 5/10

(52) U.S. Cl. 345/690

(57) ABSTRACT

A liquid crystal driving device includes a liquid crystal controller and specific color expansion circuits. The liquid crystal controller generates a liquid crystal drive signal to be supplied to a liquid crystal display panel in response to display data. The specific color expansion circuits generate an image output signal from a low-intensity image input signal corresponding to a specific color by intensifying a gradation using a specified factor. The specific color expansion circuits generate an image output signal from a high-intensity image input signal corresponding to a specific color by intensifying a gradation using another small factor. The image output signal is appropriately intensified by the specific color expansion circuits and is supplied as display data to the liquid crystal controller.

### CLAIM OF PRIORITY

The present application claims priority from Japanese application JP 2008-146458 filed on Jun. 4, 2008, the content of which is hereby incorporated by reference into this application.

### FIELD OF THE INVENTION

The present invention relates to a liquid crystal driving device and particularly to a beneficial technology capable of alleviating a decrease in intensity of an entire display screen despite a high gradation assigned to a pixel for a specific color when a specific color is enhanced.

### BACKGROUND OF THE INVENTION

Presently, there is increasing demand for a small-size liquid crystal display (LCD) for mobile devices mainly for mobile telephones. Mobile telephones tend to be multifunctional so as to be provided with not only telephony functions but also the other functions such as a five-million-pixel digital still camera (DSC), a game instrument, a video phone, and a bar code reader. In particular, the digital terrestrial television broadcasting for mobile terminal devices (one-segment broadcasting) started in April 2006. Demand for mobile telephones to not only introduce a function for viewing the television but also improve the video image quality and extend the video viewing time has increased.

Reducing power consumption is important for a small liquid crystal display used for mobile telephones. Accordingly, the backlighting light source illuminates a liquid crystal display capable of controlling the light transmittance from the rear. The transmitted light displays an image on the front of the display. The backlight consumes a large part of electricity for the liquid crystal display. Reducing the power consumption of the backlight is very effective for low power consumption of the liquid crystal display.

As described in Patent Document 1, pixel data is adjusted so as to increase the transmittance of the liquid crystal display screen. The light quantity of the backlight is accordingly decreased to save the power. As described in Patent Document 1, the power is further saved by expanding image data so that a gradation histogram of display images contains the maximum intensity data value equivalent to an intensity value indicating a specified occurrence rate from the maximum value side of intensity data, and further decreasing the light quantity of the backlight correspondingly to the expansion.

As described in Patent Document 2, the screen contrast is improved by increasing the image quality of a flesh color portion in a liquid crystal display or a plasma display. To do this, an intensity level histogram for the flesh color portion is weighted and is added to an intensity level histogram for the entire video. The result is to increase a gamma (γ) value for the flesh color portion, and the easily recognizable flesh color portion becomes brighter than an original signal. Accordingly, the display video contrast is enhanced.
Patent Document 1: Japanese Unexamined Patent Publication No. Hei 11(1999)-65531
Patent Document 2: Japanese Unexamined Patent Publication No. Hei 7(1995)-322176

### SUMMARY OF THE INVENTION

Prior to the present invention, the inventors researched and developed liquid crystal driving semiconductor integrated circuits used for mobile telephones.

In the course of the research and the development, the inventors examined in detail the flesh color enhancement technology described in Patent Document 2. The flesh color enhancement technology can make the flesh color portion brighter than the original signal and enhance the contrast of the displayed video. According to the examination, the inventors made clear that the use of the flesh color enhancement technology decreases the intensity of the entire display screen when the flesh color portion belongs to the distribution of the high gradation in the intensity histogram. When a video contains the high-intensity human flesh color, the flesh color contrast improves but the entire video intensity decreases. The inventors found the reason after the examination. The contrast decreases for pixels at the low and intermediate gradations in response to an increase in the contrast of pixels at the high gradation.

The inventors also examined in detail the backlight power saving technology described in Patent Document 1. The backlight power saving technology further decreases the light quantity of the backlight by expanding image data so that the maximum intensity data value becomes equivalent to an intensity value indicating a specified occurrence rate from the maximum value side of intensity data. In the course of the examination, the inventors also made clear that the use of the backlight power saving technology causes “whiteout.” An occurrence of “whiteout” makes it impossible to recognize a pattern of pixels at a gradation higher than the intensity value whose occurrence rate is specified.

The present invention has been made as a result of the examination made by the inventors prior to the invention.

It is therefore an object of the present invention to provide a liquid crystal driving device capable of alleviating a decrease in intensity of an entire display screen despite a high gradation assigned to a pixel for a specific color when a specific color is enhanced.

It is another object of the present invention to provide a liquid crystal driving device capable of decreasing luminescence intensity of a backlight against dark image data for low power consumption and alleviating “whiteout” in relatively bright image data when an enhancement process is performed to improve the contrast of a dark image.

These and other objects and novel features of the invention may be readily ascertained by referring to the following description and appended drawings.

The following summarizes representative aspects of the present invention disclosed in the specification.

A liquid crystal driving device (100) according to a representative embodiment of the invention includes a liquid crystal controller (107) and specific color expansion circuits (105 and 106) (see FIG. 1).

The liquid crystal controller generates a liquid crystal drive signal to be supplied to a liquid crystal display panel (12) in response to display data. The specific color expansion circuit generates an image output signal whose gradation is intensified by a specified factor (304) from an image input signal corresponding to a low-intensity specific color. The specific color expansion circuit generates an image output signal whose gradation is intensified by another small factor (308) from the image input signal corresponding to a high-intensity specific color (see FIGS. 3(A) and 3(B)). The image output signal generated by the specific color expansion circuit is supplied as the display data to the liquid crystal controller (107).

The following summarizes effects resulting from the representative aspects of the present invention disclosed in the specification.

Embodiments of the invention can provide a liquid crystal driving device capable of alleviating a decrease in intensity of an entire display screen despite a high gradation assigned to a pixel for a specific color.

### BRIEF DESCRIPTION OF THE DRAWINGS

FIG. 1 shows a configuration of a liquid crystal driver according to an embodiment of the invention;

FIG. 2 shows a configuration of a display data processing circuit included in the liquid crystal driver according to the embodiment of the invention shown in FIG. 1;

FIGS. 3(A) through 3(C) illustrate operations of an enhancement process for specific colors executed in the display data processing circuit according to the embodiment of the invention shown in FIG. 2;

FIG. 4 shows a configuration of a liquid crystal driver that drives a liquid crystal display panel and a backlight according to another embodiment of the invention;

FIGS. 5(A) through 5(C) illustrate operations of a weight process for specific colors executed in the display data processing circuit in the liquid crystal driver according to the other embodiment of the invention shown in FIG. 4;

FIG. 6 shows relation between a backlight synthesis histogram and a threshold gradation level from output of an adder included in the display data processing circuit of the liquid crystal driver shown in FIG. 4;

FIGS. 7(A) through 7(C) illustrate an enhancement process for display image data executed in a data expansion circuit of the liquid crystal driver shown in FIG. 4;

FIGS. 8(A) and 8(B) illustrate an enhancement process for display image data with specific color executed in the data expansion circuit of the liquid crystal driver shown in FIG. 4; and

FIG. 9 illustrates how the other embodiment of the invention displays display image data on a liquid crystal display panel of a mobile telephone.

### DETAILED DESCRIPTION OF THE PREFERRED EMBODIMENTS

The following describes overviews of representative embodiments disclosed in the present application. Parenthesized reference numerals in the drawings are contained in the overview of the representative embodiment and just exemplarily show instances contained in the concept of constituent elements assigned the reference numerals.

<1> According to a representative embodiment of the invention, a liquid crystal driving device (100) includes a liquid crystal controller (107) and specific color expansion circuits (105 and 106).

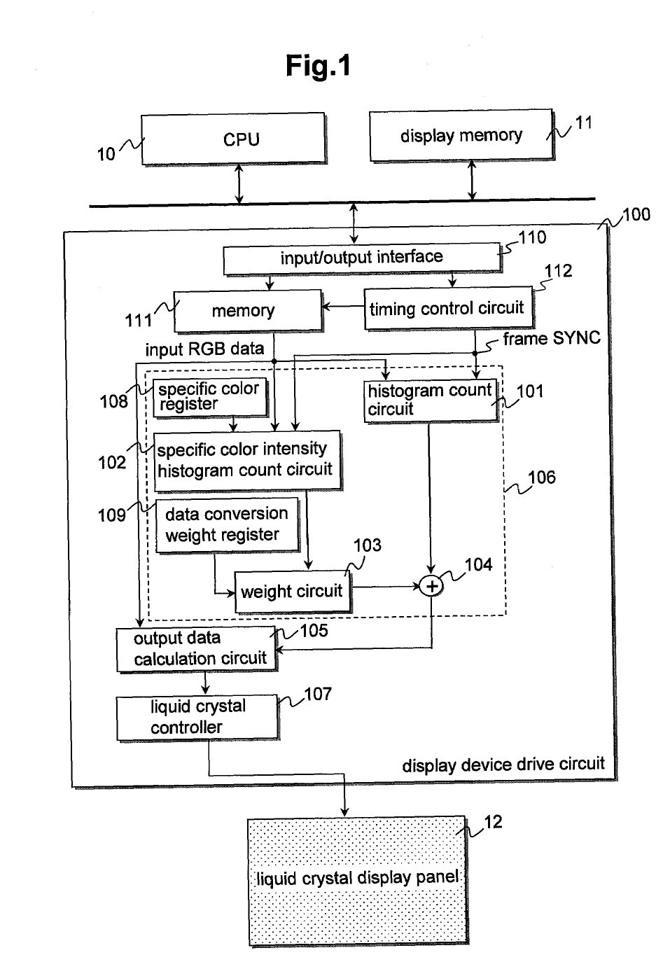

The liquid crystal controller generates a liquid crystal drive signal to be supplied to a liquid crystal display panel (12) in response to display data (see FIG. 1).

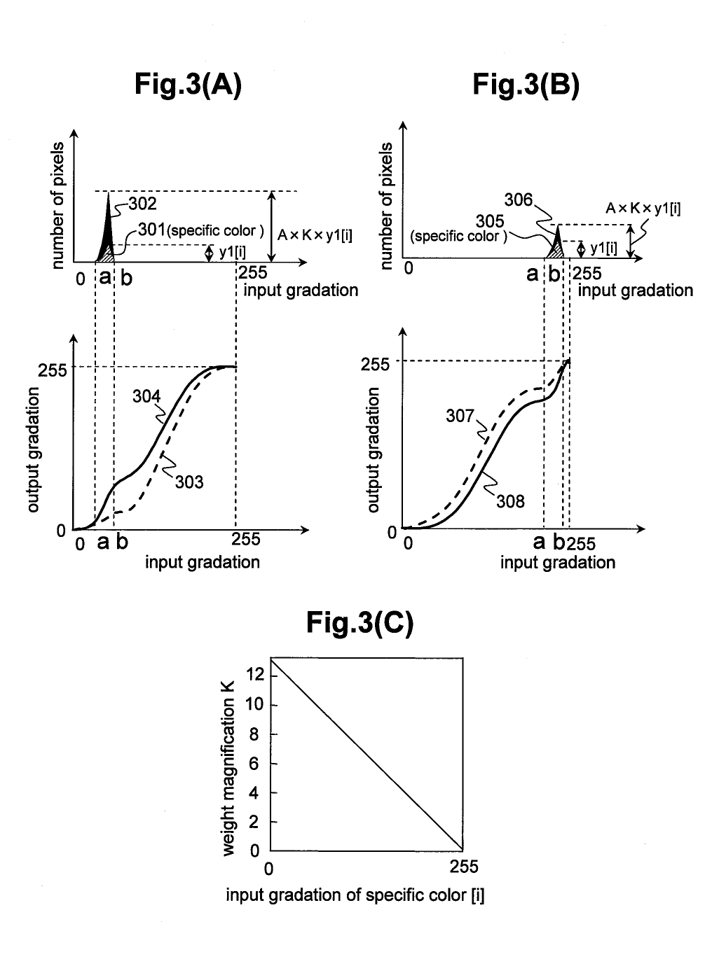

The specific color expansion circuit generates an image output signal whose output gradation is intensified by a specified factor (304) from an input gradation of an image input signal corresponding to a low-intensity specific color having a specified hue (see FIG. 3(A)).

When the image input signal corresponding to the specific color indicates a high intensity, the specific color expansion circuit generates an image output signal whose output gradation is intensified from the high-intensity image input signal using another factor (308) smaller than the specified factor (304) (see FIG. 3(B)).

The image output signal generated by the specific color expansion circuit (105 or 106) is supplied as display data to the liquid crystal controller (107).

According to the embodiment, an image input signal corresponding to the specific color is enhanced and is displayed on the liquid crystal display panel, and a small enhancement factor is used when a high intensity is applied to the image input signal corresponding to the specific color. Accordingly, it is possible to solve the conventional problem that the use of a large enhancement factor for enhancing an image input signal corresponding to a high-intensity specific color relatively decreases intensities of pixels corresponding to the low- and intermediate-intensity specific color and decreases the intensity of the entire display screen.

According to a preferred embodiment, the specific color expansion circuit (105 or 106) determines the specified factor (304) and the other factor (308) in proportion to a variable weight magnification (K) and determines a value for the variable weight magnification in inverse proportion to the image input signal corresponding to the specific color (see FIG. 3(C)).

According to a more preferred embodiment, the specific color expansion circuit includes a specific color register (108) and a specific color intensity histogram count circuit (102).

The register previously stores specific color identification information. The specific color intensity histogram count circuit generates a specific color intensity histogram for the image input signal corresponding to the specific color in accordance with the specific color identification information stored in the register.

According to another preferred embodiment, the specific color expansion circuit further includes a weight circuit (103), a base histogram count circuit (101), and an adder (104).

The weight circuit uses the variable weight magnification (K) to perform weight calculation on the specific color intensity histogram generated by the specific color intensity histogram count circuit (102). A result of the weight calculation by the weight circuit is supplied to one input terminal of the adder.

The base histogram count circuit generates a base intensity histogram for the background image from a supplied background image. The base intensity histogram is supplied to another input terminal of the adder.

An output from the adder controls a gamma correction characteristic of the specific color expansion circuit (105 or 106).

According to a specific embodiment, the liquid crystal driving device (100) further includes backlight processing circuits (401 through 404) and a backlight controller (405).

The backlight controller generates a backlight drive signal to be supplied to a backlight (13) in response to data from the backlight processing circuit.

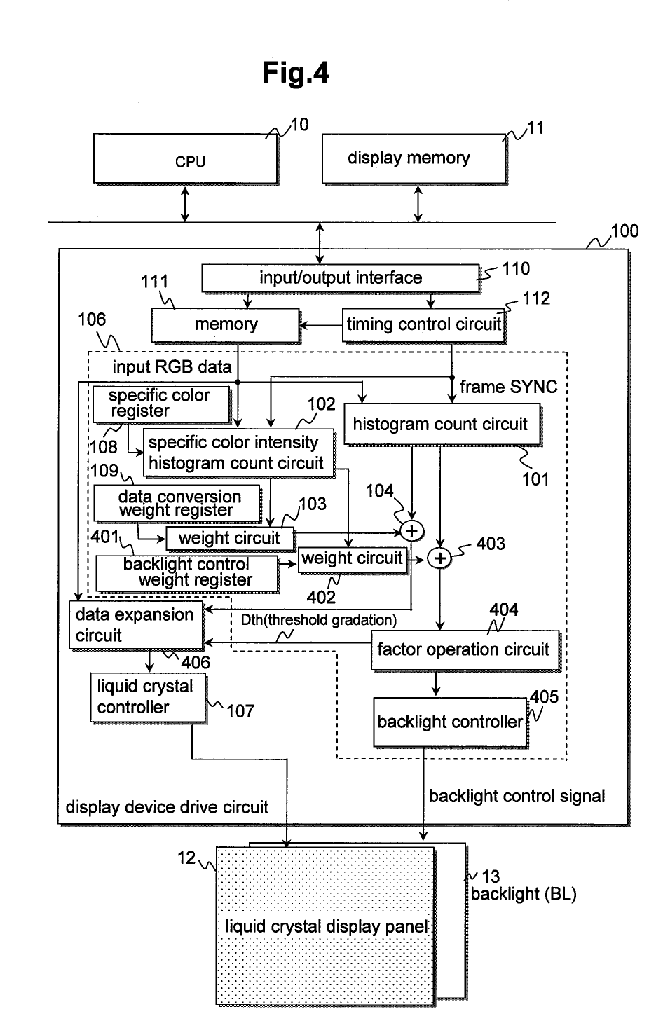

When the liquid crystal controller (107) supplies low-intensity image data to the liquid crystal display panel (12), the backlight processing circuit decreases luminescence intensity of the backlight (13). The specific color expansion circuit (106 or 406) intensifies a gradation of the low-intensity image data to improve contrast of the liquid crystal display panel (12) (see FIG. 4).

The backlight processing circuit (401 through 404) generates a threshold gradation level (Dth) of a specified occurrence rate (X %) with reference to a maximum intensity value for the image data based on the base intensity histogram created by the base histogram count circuit.

The threshold gradation level generated from the backlight processing circuit is supplied to the specific color expansion circuit (105 or 106). The specific color expansion circuit uses a specified stretch factor (α>1) to intensify a gradation of the image data having a lower intensity than the threshold gradation level.

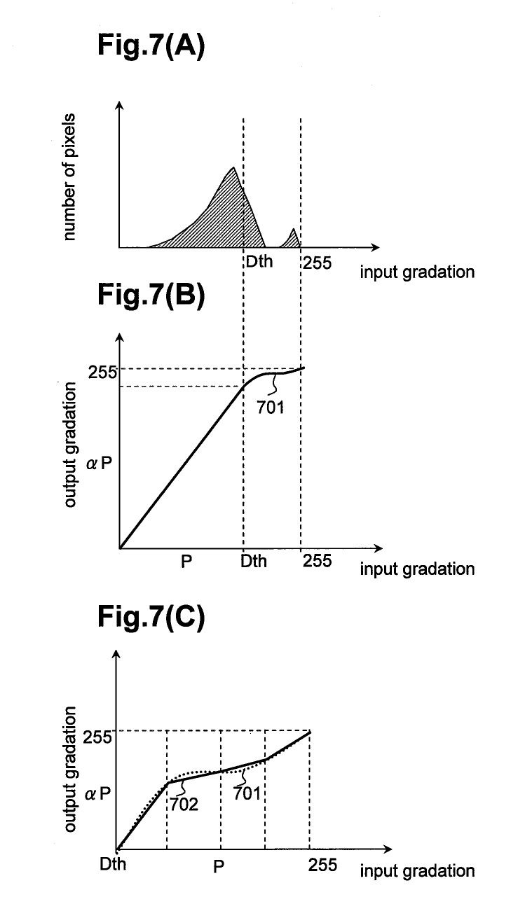

The specific color expansion circuit uses another stretch factor (α<1) smaller than the specified stretch factor to intensify a gradation of the image data having an intensity higher than the threshold gradation level (see FIGS. 7(A) through (C)).

According to still another embodiment, the backlight processing circuit includes a second weight circuit (402), a second adder (403), and an operation circuit (404).

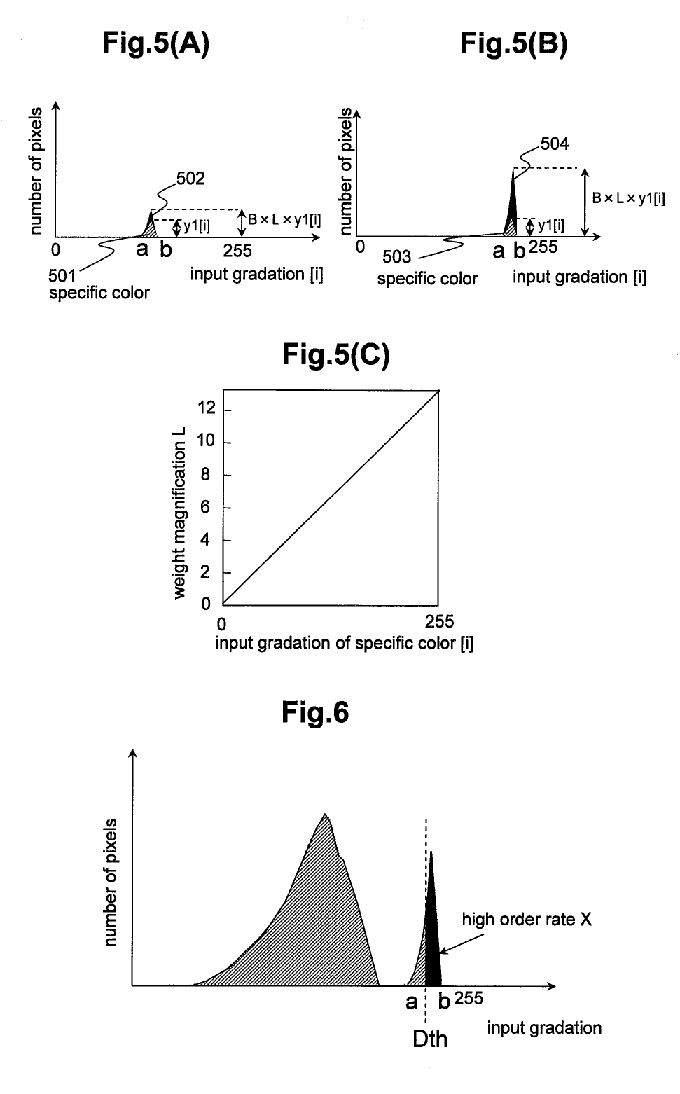

The second weight circuit uses a second variable weight magnification (L) to perform a second weight calculation on the specific color intensity histogram generated by the specific color intensity histogram count circuit (102). A result of the second weight calculation from the second weight circuit is supplied to one input terminal of the second adder. A value (L) for the second variable weight magnification is determined in proportion to the image input signal having the specific color (see FIG. 5(C)).

The base intensity histogram generated from the base histogram count circuit (101) is supplied to another input terminal of the second adder (403).

The calculation circuit (404) generates the threshold gradation level (Dth) based on an output from the second adder (see FIG. 4).

According to a most specific embodiment, the liquid crystal driving device (100) is integrated as a semiconductor integrated circuit chip.

According to another most specific embodiment, the specific color expansion circuit generates an image output signal that intensifies a gradation of an image input signal having flesh color as the image input signal having the specific color (see FIG. 4).

<2> According to another representative embodiment of the invention, a liquid crystal driving device (100) includes: a display data processing circuit (106 or 406); a liquid crystal controller (107); a backlight data processing circuit (401 through 404); and a backlight controller (405).

The display data processing circuit (106 or 406) generates display data to be supplied to the liquid crystal controller. The liquid crystal controller generates a liquid crystal drive signal to be supplied to a liquid crystal display panel (12) in response to the display data.

The display data processing circuit includes a base histogram count circuit (101) that generates a base intensity histogram for the background image from a supplied background image.

The backlight data processing circuit generates backlight data to be supplied to the backlight controller. The backlight controller generates a backlight drive signal to be supplied to a backlight (13) in response to the backlight data.

When the liquid crystal controller (107) supplies low-intensity image data to the liquid crystal display panel (12), the backlight processing circuit decreases luminescence intensity of the backlight (13). The display data processing circuit (106 or 406) intensifies a gradation of the low-intensity image data to improve contrast of the liquid crystal display panel (12) (see FIG. 4).

The backlight processing circuit (401 through 404) generates a threshold gradation level (Dth) of a specified occurrence rate (X %) with reference to a maximum intensity value for the image data based on the base intensity histogram created by the base histogram count circuit.

The threshold gradation level generated from the backlight processing circuit is supplied to the display data processing circuit (106 or 406). The display data processing circuit uses a specified stretch factor (α>1) to intensify a gradation of the image data having a lower intensity than the threshold gradation level.

The display data processing circuit uses another stretch factor (α<1) smaller than the specified stretch factor to intensify a gradation of the image data having an intensity higher than the threshold gradation level (see FIGS. 7(A) through (C)).

The embodiment is capable of decreasing luminescence intensity of a backlight against dark image data for low power consumption and alleviating “whiteout” in relatively bright image data when an enhancement process is performed to improve the contrast of a dark image.

According to a preferred embodiment, the display data processing circuit (106 or 406) includes a specific color expansion circuit (102 through 104) that generates an image output signal whose output gradation is intensified by a specified factor (304) from an input gradation of an image input signal corresponding to a low-intensity specific color having a specified hue.

When the image input signal corresponding to the specific color indicates a high intensity, the specific color expansion circuit generates an image output signal whose output gradation is intensified by another factor (308) smaller than the specified factor (304) from the high-intensity image input signal (see FIG. 3(B)).

The image output signal generated by the specific color expansion circuit (102 through 104) is supplied as display data to the liquid crystal controller (107).

According to a more preferred embodiment, the liquid crystal driving device (100) is integrated as a semiconductor integrated circuit chip.

### Description of Embodiments

The following describes the embodiments in more detail. Throughout all the drawings for illustrating the preferred embodiments of the invention, parts having the same function as preceding drawings are designated by the same reference numerals and a detailed description is omitted for simplicity.

<Liquid Crystal Display Device Configuration>

FIG. 1 shows a configuration of a liquid crystal driver (display device drive circuit) 100 according to an embodiment of the invention. The liquid crystal driver 100 includes internal blocks 101 through 112. Peripheral devices 10 through 12 are coupled with the liquid crystal driver 100 to configure the liquid crystal display device.

The liquid crystal driver 100 includes internal blocks such as an output data calculation circuit 105, a display data processing circuit 106, a liquid crystal controller 107, a system input/output interface 110, a graphic memory 111, and a timing control circuit 112

The display data processing circuit 106 as a block includes a histogram count circuit 101, a specific color intensity histogram count circuit 102, a weight circuit 103, an adder 104, a specific color register 108, and a data conversion weight register 109. The liquid crystal driver 100 is externally coupled with a central processing unit 10, display memory 11, and a liquid crystal display panel 12.

In this manner, the liquid crystal driver 100 includes the internal blocks 105 through 107 and 110 through 112 and is integrated as a large scale integrated (LSI) circuit over a silicon chip. The liquid crystal driver 100 drives and controls the liquid crystal display panel 12.

As shown in FIG. 1, the system input/output interface 110 of the liquid crystal driver 100 is coupled with the central processing unit 10 at an outside. The system input/output interface 110 receives control data in the liquid crystal driver 100, display data supplied to the graphic memory 111, and a timing signal supplied to the timing control circuit 112 from the central processing unit 10.

The central processing unit 10 generates display data, control data, and a timing signal. The display data, the control data, and the timing signal are transferred from the central processing unit 10 to the system input/output interface 110 of the liquid crystal driver 100. The control data is transferred from the system input/output interface 110 to the inside of the liquid crystal driver 100. The display data is transferred from the system input/output interface 110 to the graphic memory 111. The timing signal is transferred from the system input/output interface 110 to the timing control circuit 112.

The specific color intensity histogram count circuit 102 creates a second histogram in accordance with specific color recognition information previously stored in the specific color register 108. The second histogram is associated with intensity levels of a specific color contained in image input data from the graphic memory 111 in accordance with the specific color recognition information previously stored in the specific color register 108. That is, the intensity level histogram counts the number of pixels corresponding to each intensity level of the specific color. For example, the specific color represents conspicuous flesh color.

In order to extract intensity levels in a background image, the histogram count circuit 101 as a base creates a first histogram corresponding to intensity levels for the number of pixels in one image frame of all image input data from the graphic memory 111. The first histogram is mainly used to count the number of pixels corresponding to each intensity level in a background image.

The data conversion weight register 109 stores a constant weight magnification A used for the weight process executed in the weight circuit 103. Accordingly, the weight circuit 103 performs weight calculation on data in the second histogram from the specific color intensity histogram count circuit 102 using the constant weight magnification A. The weight circuit 103 uses a variable weight magnification K for weight calculation on data in the second histogram. A value of the variable weight magnification K varies with the intensity level for the specific color. The value of the variable weight magnification K increases as the intensity level for the specific color decreases. The value of the variable weight magnification K decreases as the intensity level for the specific color increases.

The weight circuit 103 applies the weight process to the second histogram for the specific color using the constant weight magnification A and the variable weight magnification K. The histogram count circuit 101 as the base processes the first histogram. The adder 104 adds the second histogram and the first histogram together. Accordingly, an output from the adder 104 generates a synthesis histogram as an output from the display data processing circuit 106. The synthesis histogram is supplied to the output data calculation circuit 105. The output data calculation circuit 105 determines a gamma (γ) value in accordance with the synthesis histogram supplied from the adder 104. Using the γ value, the output data calculation circuit 105 performs gamma correction on image input data (RGB) read from the graphic memory 111. The liquid crystal controller 107 is supplied with the image input data (RGB) that is gamma-corrected by the output data calculation circuit 105.

The liquid crystal controller 107 supplies the image output data (RGB) to an internal source line drive circuit. In response to the image output data, the source line drive circuit generates a liquid crystal source drive signal to be supplied to the liquid crystal display panel 12. A gradation voltage is generated from a gradation voltage generation circuit and is supplied to a source line drive circuit. A liquid crystal drive level generation circuit supplies a liquid crystal gate drive signal and a common drive signal to be supplied to the liquid crystal display panel 12.

The active matrix liquid crystal display panel 12 uses a low temperature poly-silicon (LTPS) thin-film transistor (TFT) color liquid crystal display that features low profile, light weight, and low power consumption. The TFT is formed by depositing low temperature poly-silicon over a glass surface of the liquid crystal display panel 12.

The active matrix liquid crystal display panel 12 includes a TFT switching element, a storage capacitor, and a liquid crystal cell at an intersection point between a signal electrode line (source line) and a scanning electrode line (gateline). One ends of multiple liquid crystal cells in the liquid crystal display panel 12 are coupled with drain electrodes of multiple TFT switching elements. The other ends thereof are coupled with a common electrode. The common electrode is supplied with a common drive signal from the liquid crystal drive level generation circuit. The polarity of the common drive signal is cyclically reversed so as to prevent the liquid crystal from being polarized. Multiple liquid crystal source drive signals from the source line drive circuit drive multiple horizontal signal electrode lines (source lines) of the liquid crystal display panel 12. The liquid crystal gate drive signal from the liquid crystal drive level generation circuit drives multiple vertical scanning electrode lines (gate lines) of the liquid crystal display panel 12.

<Display Data Processing Circuit Configuration>

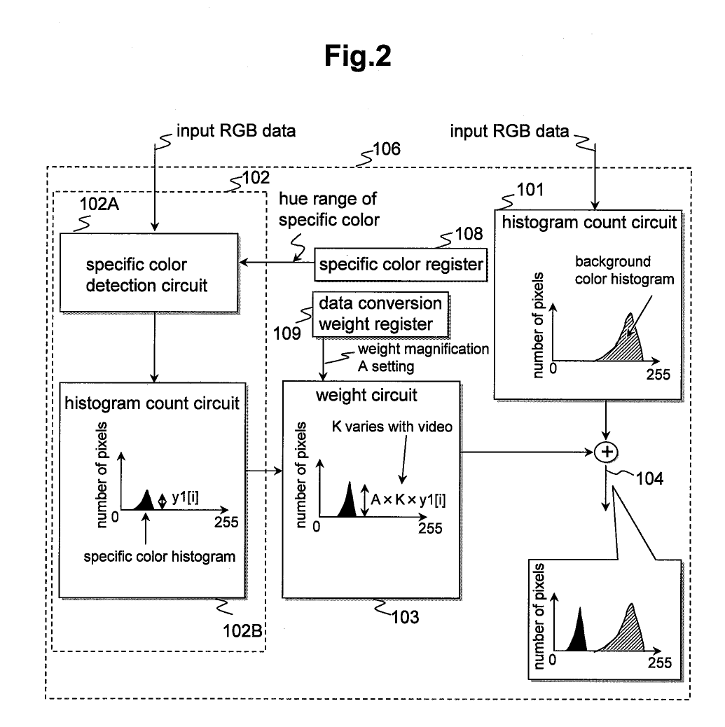

FIG. 2 shows a configuration of the display data processing circuit 106 included in the liquid crystal display panel 100 according to the embodiment of the invention shown in FIG. 1. As shown in FIG. 2, the specific color intensity histogram count circuit 102 in the display data processing circuit 106 includes a specific color detection circuit 102A and a histogram count circuit 102B.

The image input data (RGB) is read from the graphic memory 111 via the timing control circuit 112 and is supplied to one input terminal of the specific color detection circuit 102A in the display data processing circuit 106. The specific color register 108 previously stores setup information for configuring a specific hue (e.g., flesh color) to be intensified by the enhancement process. For example, when the specific hue to be intensified is the flesh color, it is necessary to ensure signal level 1.3 to 1.7 for red (R) and signal level 1.1 to 1.3 for green (G) to signal level 1 for blue (B) in the three primary colors, so as to be recognized as the flesh color. Recognition information about the three primary colors is previously stored in the specific color register 108. The specific color recognition information stored in the specific color register 108 is supplied to the other input terminal of the specific color detection circuit 102A. Accordingly, the specific color detection circuit 102A extracts pixels for the specific color from the image input data supplied to the one input terminal and supplies the extracted pixels to the histogram count circuit 102B. The histogram count circuit 102B creates an intensity level histogram for the specific color. As shown in FIG. 2, this second histogram counts the number of pixels y1[i] for the specific color at each intensity level i for the specific color.

The weight circuit 103 is supplied with the second histogram for the specific color generated from the histogram count circuit 102B in the specific color intensity histogram count circuit 102. The weight circuit 103 uses the constant weight magnification A from the data conversion weight register 109 to perform weight calculation on data in the second histogram supplied from the specific color intensity histogram count circuit 102. The weight circuit 103 also uses the variable weight magnification K for the weight calculation on data in the second histogram. A value of the variable weight magnification K varies with the intensity level for the specific color. The value of the variable weight magnification K increases as the intensity level for the specific color decreases. The value of the variable weight magnification K decreases as the intensity level for the specific color increases. For example, the weight circuit 103 contains a look-up table (LUT) that stores variable weight magnifications K corresponding to intensity levels of the specific color. The weight circuit 103 performs the weight calculation using the variable weight magnification K read from the LUT in accordance with the intensity level of the specific color.

As shown in FIG. 2, the image input data (RGB) is supplied to the histogram count circuit 101 as the base similarly to the specific color intensity histogram count circuit 102. The histogram count circuit 101 counts the number of pixels corresponding to intensities of the image input data. As a result, the first histogram in the histogram count circuit 101 in FIG. 2 mainly counts the number of pixels corresponding to each intensity level of the background image. The second histogram in the weight circuit 103 in FIG. 2 performs the weight calculation using the constant weight magnification A supplied from the data conversion weight register 109 and the variable weight magnification K. A value of the variable weight magnification K varies with the intensity level for the specific color. The value of the variable weight magnification K increases as the intensity level for the specific color decreases. The value of the variable weight magnification K decreases as the intensity level for the specific color increases.

In FIG. 2, a histogram for the background image is shown in black. A histogram for the specific color is shaded. A synthesis histogram output from the adder 104 shows that the enhancement process enhances the number of pixels for the specific color at a low-intensity signal level compared to the number of pixels in the background image at a high-intensity signal level.

<Enhancement Process For the Specific Color>

FIGS. 3(A) to 3(C) illustrate operations of the enhancement process for the specific color performed by the display data processing circuit 106 according to the embodiment of the invention shown in FIG. 2.

At the top of FIG. 3(A), a shaded portion represents distribution 301 of the number of pixels corresponding to low intensity levels of the specific color in the second histogram generated from the specific color intensity histogram count circuit 102. At the top of FIG. 3(A), a black portion represents distribution 302 of the number of pixels corresponding to low intensity levels of the specific color after the weight circuit 103 performs the weight process using the constant weight magnification A and the variable weight magnification K. In FIG. 3(A), a large value is assigned to the variable weight magnification K because the intensity level for the specific color is low. In the case of FIG. 3(A), the enhancement process can enhance the number of pixels for the specific color at the low intensity signal level compared to the number of pixels in the background image at the high intensity signal level as seen from the synthesis histogram output from the adder 104 in FIG. 2. As shown in FIG. 1, the synthesis histogram from the adder 104 is supplied to the output data calculation circuit 105. The output data calculation circuit 105 determines a gamma (γ) value in accordance with the synthesis histogram. The output data calculation circuit 105 uses the γ value to perform gamma correction on the image input data (RGB) read from the graphic memory 111. That is, the total number of pixels in the synthesis histogram from the adder 104 determines gamma correction characteristics from the input gradation to the output gradation in the output data calculation circuit 105.

The bottom part of FIG. 3(A) shows that characteristic 303 changes to characteristic 304 in terms of the gamma correction characteristic between the input and output gradations from the output data calculation circuit 105 when the intensity level for the specific color is low. The characteristic 304 represents the gamma correction characteristic between the input and output gradations from the output data calculation circuit 105 when the intensity level for the specific color is high.

When the intensity level for the specific color is low as shown in FIG. 3(A), the image output signal for the specific color from the output data calculation circuit 105 corresponds to the image input signal having low input gradations a and b. The image output signal is capable of increasing the gradation and the intensity. Accordingly, it is possible to the contrast of pixels for the specific color corresponding to the low and medium gradations.

At the top of FIG. 3(B), a shaded portion represents distribution 305 of the number of pixels corresponding to high intensity levels of the specific color in the second histogram generated from the specific color intensity histogram count circuit 102. At the top of FIG. 3(B), a black portion represents distribution 306 of the number of pixels corresponding to high intensity levels of the specific color after the weight circuit 103 performs the weight process using the constant weight magnification A and the variable weight magnification K. In FIG. 3(B), a small value is assigned to the variable weight magnification K because the intensity level for the specific color is high. In the case of FIG. 3(B), the enhancement process does not remarkably enhance the number of pixels for the specific color at the high intensity signal level compared to the number of pixels in the background image at the high intensity signal level as seen from the synthesis histogram output from the adder 104 in FIG. 2. The total number of pixels in the synthesis histogram from the adder 104 determines gamma correction characteristics from the input gradation to the output gradation in the output data calculation circuit 105 shown in FIG. 1.

The bottom part of FIG. 3(B) shows that characteristic 307 changes to characteristic 308 in terms of the gamma correction characteristic between the input and output gradations from the output data calculation circuit 105 when the intensity level for the specific color is high. The characteristic 307 represents the gamma correction characteristic between the input and output gradations from the output data calculation circuit 105 when the intensity level for the specific color is low.

When the intensity level for the specific color is high as shown in FIG. 3(B), the image output signal for the specific color from the output data calculation circuit 105 corresponds to the image input signal having high input gradations a and b. The image output signal is capable of decreasing the gradation and the intensity. As described with reference to FIGS. 1, 2, and 3(A) to 3(C), the embodiment of the invention can solve the conventional problem that increasing the intensity of pixels for the specific color at a high gradation decreases the intensity of pixels at relatively low and medium gradations.

FIG. 3(C) shows relation between the variable weight magnification K and the intensity level for the specific color the weight circuit 103 uses for the weight calculation of data in the second histogram. A value of the variable weight magnification K varies with the intensity level for the specific color. The value of the variable weight magnification K increases as the intensity level for the specific color decreases. The value of the variable weight magnification K decreases as the intensity level for the specific color increases.

<Liquid Crystal Driver For Driving a Liquid Crystal Display Panel and a Backlight>

FIG. 4 shows a configuration of a liquid crystal driver 100 that drives the liquid crystal display panel 12 and a backlight 13 according to another embodiment of the invention.

Most of recently available liquid crystal displays are transmissive or semi-transmissive and require a backlight. The backlight uses a white light emitting diode (LED) because it consumes low power, has a long service life, and easily ensures small size and light weight. As the most general structure of commercialized white LEDs, a semiconductor LED that glows blue is combined with a fluorescence substance that glows yellow when irradiated with the blue light. Such white LEDs are manufactured mainly as backlights for mobile telephones.

In the liquid crystal display device as shown in FIG. 4, the backlight 13 uses the above-mentioned multiple white LEDs as a light source. The backlight 13 contains a built-in power supply. The built-in power supply of the backlight 13 supplies the white LEDs with a forward current as a drive current. The drive current supplied to the white LEDs controls the luminescence intensity of the backlight 13.

In order to allow the liquid crystal driver 100 to drive the liquid crystal display panel 12, similarly to the liquid crystal driver 100 in FIG. 1, the display data processing circuit 106 as a block includes the histogram count circuit 101, the specific color intensity histogram count circuit 102, the weight circuit 103, the adder 104, the specific color register 108, and the data conversion weight register 109. The liquid crystal driver 100 in FIG. 4 further includes a data expansion circuit 406 equivalent to the data calculation circuit 105 of the liquid crystal driver 100 in FIG. 1. Similarly to the liquid crystal driver 100 in FIG. 1, the liquid crystal driver 100 in FIG. 4 can increase the gradation and the intensity of an image output signal for the specific color from the data expansion circuit 406 when the intensity level for the specific color is low. In addition, the liquid crystal driver 100 in FIG. 4 can decrease the gradation and the intensity of an image output signal for the specific color from the data expansion circuit 406 when the intensity level for the specific color is high.

The liquid crystal driver 100 in FIG. 4 drives the backlight 13 in addition to the liquid crystal display panel 12. Compared to the liquid crystal driver 100 in FIG. 1, the display data processing circuit 106 is additionally provided with a backlight control weight register 401, a weight circuit 402, an adder 403, a factor operation circuit 404, and a backlight controller 405.

The backlight control weight register 401 includes a constant weight magnification B used for the weight process executed in the weight circuit 402. The weight circuit 402 uses the constant weight magnification B supplied from the backlight control weight register 401 to perform a weight calculation on data in the second histogram from the specific color intensity histogram count circuit 102. The weight circuit 402 also uses a variable weight magnification L for the weight calculation on data in the second histogram. A value of the variable weight magnification L varies with the intensity level for the specific color. The value of the variable weight magnification L decreases as the intensity level for the specific color decreases. The value of the variable weight magnification L increases as the intensity level for the specific color increases. For example, the weight circuit 402 contains a look-up table (LUT) that stores variable weight magnifications L corresponding to intensity levels of the specific color. The weight circuit 402 performs the weight calculation using the variable weight magnification L read from the LUT in accordance with the intensity level of the specific color.

The weight circuit 402 applies the weight process to a third histogram for the specific color using the constant weight magnification B and the variable weight magnification L. The background histogram count circuit 101 as the base processes the first histogram as the base. The adder 403 adds the first and third histograms. Consequently, a backlight synthesis histogram is generated from an output from the adder 403 and is supplied to the factor operation circuit 404. The factor operation circuit 404 multiplies the backlight synthesis histogram generated from an output from the adder 403 by a specified factor and supplies a multiplication result to the backlight controller 405. Accordingly, the backlight controller 405 controls the drive current of the backlight 13 in response to the process result from the adder 403. The drive current and the luminescence intensity of the backlight 13 are configured in proportion to the total number of pixels for the specific color and the background color included in the multiplication result from the factor operation circuit 404.

FIGS. 5(A), 5(B), and 5(C) illustrate operations of the weight process for the specific color executed in the weight circuit 402 in the display data processing circuit 106 in the liquid crystal driver 100 according to the other embodiment of the invention as shown in FIG. 4.

At the top of FIG. 5(A), a shaded portion represents distribution 501 of the number of pixels corresponding to low intensity levels of the specific color in the second histogram generated from the specific color intensity histogram count circuit 102. At the top of FIG. 5(A), a black portion represents distribution 502 of the number of pixels corresponding to low intensity levels of the specific color after the weight circuit 402 performs the weight process using the constant weight magnification B and the variable weight magnification L. In FIG. 5(A), a small value is assigned to the variable weight magnification L because the intensity level for the specific color is low.

In the case of 5(A), the weight process using the variable weight magnification L assigned with a small value slightly enhances the number of pixels for the specific color at the low intensity signal level. As a result, the backlight 13 is supplied with a small drive current and a small luminescence intensity when the multiplication result from the factor operation circuit 404 includes a low intensity signal level of pixels for the specific color and the background color. When the liquid crystal display panel 12 displays a dark image of image data, decreasing the luminescence intensity for the backlight 13 can reduce the power consumption.

At the top of FIG. 5(B), a shaded portion represents distribution 503 of the number of pixels corresponding to high intensity levels of the specific color in the second histogram generated from the specific color intensity histogram count circuit 102. At the top of FIG. 5(B), a black portion represents distribution 504 of the number of pixels corresponding to high intensity levels of the specific color after the weight circuit 402 performs the weight process using the constant weight magnification B and the variable weight magnification L. In FIG. 5(B), a large value is assigned to the variable weight magnification L because the intensity level for the specific color is high.

In the case of FIG. 5(B), the weight process greatly enhances the number of pixels of the specific color at a relatively high intensity signal level using the variable weight magnification L assigned with a large value. As a result, the backlight 13 is supplied with a large drive current and a large luminescence intensity when the multiplication result from the factor operation circuit 404 includes a relatively high intensity signal level of pixels for the specific color and the background color. When the liquid crystal display panel 12 displays a relatively bright image of image data, increasing the luminescence intensity for the backlight 13 can increase the intensity of the image data displayed on the liquid crystal display panel 12.

FIG. 5(C) shows relation between the variable weight magnification L and the intensity level for the specific color the weight circuit 402 uses for the weight calculation of data in the third histogram. A value of the variable weight magnification L varies with the intensity level for the specific color. The value of the variable weight magnification L decreases as the intensity level for the specific color decreases. The value of the variable weight magnification L increases as the intensity level for the specific color increases.

As shown in FIG. 4, the factor operation circuit 404 in the liquid crystal driver 100 according to the other embodiment of the invention generates a threshold gradation level Dth from the backlight synthesis histogram generated from an output from the adder 403. The threshold gradation level Dth is supplied to the data expansion circuit 406.

The liquid crystal driver 100 shown in FIG. 4 decreases the luminescence intensity of the backlight 13 and reduces the power consumption when the display image data allows the liquid crystal display panel 12 to display a dark image. To do this, the liquid crystal driver 100 uses the functions of the backlight control weight register 401, the weight circuit 402, the adder 403, the factor operation circuit 404, and the backlight controller 405 in the display data processing circuit 106. When the display image data provides a dark image, however, simply dimming the backlight 13 darkens the displayed image. To solve this problem, the data expansion circuit 406 performs an enhancement process on low-intensity display image data and improves the contrast of the image displayed on the liquid crystal display panel 12. The data expansion circuit 406 can perform the enhancement process on display image data by changing a gamma (γ) value, i.e., the gamma correction characteristic between input and output gradations. When the enhancement process is performed on an image representing very bright display image data, however, the above-mentioned “whiteout” occurs and a pattern of high-gradation pixels becomes unidentifiable.

The liquid crystal driver 100 in FIG. 4 solves an occurrence of “whiteout” as follows. The data expansion circuit 406 uses the threshold gradation level Dth supplied from the factor operation circuit 404 and decreases a stretch factor for the enhancement process corresponding to the display image data having a higher intensity than the threshold gradation level Dth. The data expansion circuit 406 improves the contrast of the image displayed on the liquid crystal display panel 12 by increasing the stretch factor for the enhancement process applied to the display image data having a lower intensity than the threshold gradation level Dth. Similarly to the liquid crystal driver 100 in FIG. 1, the background histogram count circuit 101, the specific color intensity histogram count circuit 102, the weight circuit 103, the adder 104, the specific color register 108, and the data conversion weight register 109 included in the display data processing circuit 106 control the enhancement process in the data expansion circuit 406.

In the liquid crystal driver 100 as shown in FIG. 4, the factor operation circuit 404 determines the threshold gradation level Dth in accordance with the distribution of intensities of the display image data included in the backlight synthesis histogram from the output of the adder 403. As described in Patent Document 1, the factor operation circuit 404 calculates an intensity value indicating a specified occurrence rate from the maximum value side of intensity data in the gradation histogram for the displayed image and assigns this intensity value to the threshold gradation level Dth. That is, the factor operation circuit 404 generates the threshold gradation level Dth from the distribution of intensities of display image data contained in the backlight synthesis histogram generated from the output of the adder 403. The generated threshold gradation level Dth is supplied to the data expansion circuit 406.

FIG. 6 shows relation between the backlight synthesis histogram and the threshold gradation level Dth from output of the adder 403 included in the display data processing circuit 106 of the liquid crystal driver 100 shown in FIG. 4.

The factor operation circuit 404 configures the threshold gradation level Dth that is an intensity value corresponding to occurrence rate X as a percentage of the maximum gradation value 255 for intensity data in the backlight synthesis histogram shown in FIG. 6. An example in FIG. 6 shows that the threshold gradation level Dth is located between intensities a and b as display image data distributed at the high-intensity side.

FIGS. 7(A) through 7(C) illustrate the enhancement process for display image data executed in the data expansion circuit 406 of the liquid crystal driver 100 shown in FIG. 4.

FIG. 7(A) shows a synthesis histogram generated from an output of the adder 104 included in the display data processing circuit 106. Similarly to the backlight synthesis histogram in FIG. 6, the synthesis histogram in FIG. 7(A) contains a first distribution of pixels corresponding to low and intermediate intensities and a second distribution of pixels corresponding to a high intensity. In FIG. 7(A), a peak pixel value for the second distribution is smaller than that in FIG. 6. The backlight synthesis histogram in FIG. 6 shows that the threshold gradation level Dth belongs to the second distribution of pixels corresponding to the high intensity. The synthesis histogram in FIG. 7(A) shows that the threshold gradation level Dth belongs to the first distribution of pixels corresponding to the low and intermediate intensities.

As shown in FIG. 7(B), the data expansion circuit 406 applies the enhancement process to display image data corresponding to the intensity P lower than the threshold gradation level Dth. The enhancement process uses a gamma correction characteristic 701 between input and output gradations based on a large stretch factor α(α>1). The stretch factor α is found as: α=255/Dth. However, the data expansion circuit 406 applies the enhancement process to display image data corresponding to the intensity P higher than the threshold gradation level Dth. The enhancement process uses the gamma correction characteristic 701 based on a stretch factor α smaller than 1 (α<1).

FIG. 7(C) is an enlarged view of part of the gamma correction characteristic 701 shown in FIG. 7(B) where the intensity is higher than the threshold gradation level Dth. The curved gamma correction characteristic 701 increases the amount of operations and requires the long operation time for the enhancement process by the data expansion circuit 406. To solve this problem, the enhancement process of the data expansion circuit 406 uses a gamma correction characteristic 702 based on straight-line approximation. The straight-line approximation of the gamma correction characteristic 702 interpolates curved portions of the gamma correction characteristic 701.

### Other Embodiments

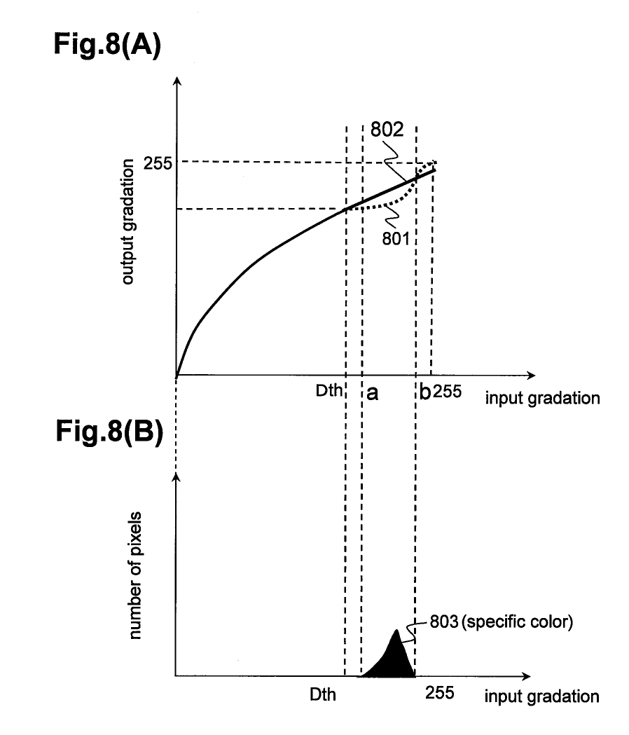

FIGS. 8(A) and 8(B) illustrate an enhancement process for display image data with specific color executed in the data expansion 406 circuit of the liquid crystal driver 100 shown in FIG. 4.

As shown in FIG. 8(A), the data expansion circuit 406 applies the enhancement process to display image data having a specific color corresponding to the intensity lower than the threshold gradation level Dth. The enhancement process uses the gamma correction characteristic 801 between input and output gradations so that the stretch factor of the enhancement process is larger than the stretch factor in FIG. 7(B).

As shown in FIG. 8(B), the display image data having the specific color is distributed between intensities a and b higher than the threshold gradation level Dth. The enhancement process for the high-intensity display image data having the specific color uses the stretch factor assigned a relatively small value as applied to a curve represented by a gamma correction characteristic 801. When the enhancement process is applied to intensities higher than the threshold gradation level Dth, decreasing the stretch factor of the enhancement process can eliminate the “whiteout” from the display image data having the specific color. According to the other embodiment of the invention, the straight-line approximation of a gamma correction characteristic 802 interpolates the curved portion of the gamma correction characteristic 801.

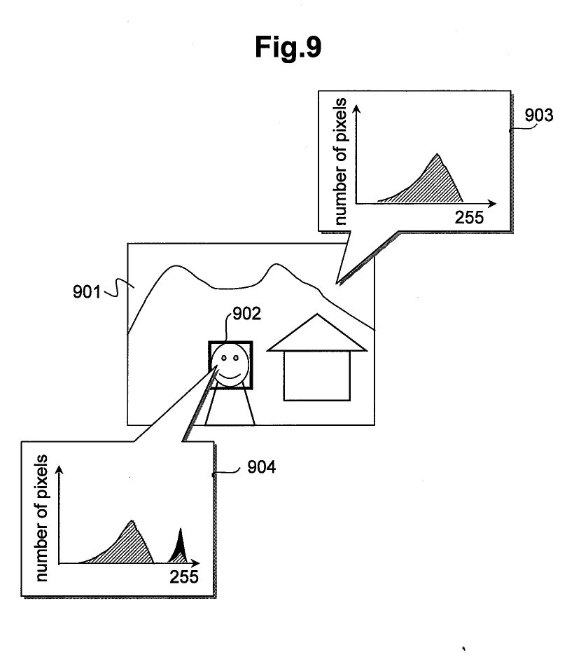

FIG. 9 illustrates how the other embodiment of the invention displays display image data on a liquid crystal display panel of a mobile telephone.

The liquid crystal display panel in FIG. 9 displays display image data including display image data 902 representing a human face in flesh color as a specific color and display image data 901 as a remaining background.

As described with reference to FIG. 8(A), the enhancement process uses a relatively large stretch factor for the display image data 902 for the face corresponding to a low-intensity specific color to increase the gradation and the intensity of the display image data 902 for the conspicuous human face. As described with reference to FIG. 8(A), however, the enhancement process uses a relatively small stretch factor for the display image data 902 of the high-intensity face to eliminate the “whiteout.”

When the display image data 901 for the background is dark as shown in FIG. 4, the luminescence intensity of the backlight is decreased to reduce the power consumption. The enhancement process is performed as shown in FIGS. 7(A) through 7(C) to improve the contrast of the dark image. When the display image data 901 for the background is bright as shown in FIG. 4, the luminescence intensity of the backlight is decreased to improve the contrast. When the image data is very bright, the stretch factor of the enhancement process is decreased to eliminate the “whiteout.”

While there have been described specific preferred embodiments of the present invention, it is to be distinctly understood that the present invention is not limited thereto but may be otherwise variously embodied within the spirit and scope of the invention.

For example, the liquid crystal driver is applicable to not only mobile telephones but also battery-operated small media players such as a DVD player mounted with a liquid crystal display.

1. A liquid crystal driving device comprising:
a liquid crystal controller; and
a specific color expansion circuit,
wherein the liquid crystal controller generates a liquid crystal drive signal to be supplied to a liquid crystal display panel in response to display data,
wherein the specific color expansion circuit generates an image output signal whose output gradation is intensified by a specified factor from an input gradation of an image input signal corresponding to a low-intensity specific color having a specified hue,
wherein, when the image input signal corresponding to the specific color indicates a high intensity, the specific color expansion circuit generates an image output signal whose output gradation is intensified from the high-intensity image input signal using another factor smaller than the specified factor, and
wherein the image output signal generated by the specific color expansion circuit is supplied as display data to the liquid crystal controller.

2. The liquid crystal driving device according to claim 1,
wherein the specific color expansion circuit determines the specified factor and the other factor in proportion to a variable weight magnification, and determines a value for the variable weight magnification in inverse proportion to the image input signal corresponding to the specific color.

3. The liquid crystal driving device according to claim 2,
wherein the specific color expansion circuit includes a specific color register and a specific color intensity histogram count circuit,
wherein the register previously stores specific color identification information, and
wherein the specific color intensity histogram count circuit generates a specific color intensity histogram for the image input signal corresponding to the specific color in accordance with the specific color identification information stored in the register.

4. The liquid crystal driving device according to claim 3,
wherein the specific color expansion circuit further includes a weight circuit, a base histogram count circuit, and an adder,
wherein the weight circuit uses the variable weight magnification to perform weight calculation on the specific color intensity histogram generated by the specific color intensity histogram count circuit, and a result of the weight calculation by the weight circuit is supplied to one input terminal of the adder,
wherein the base histogram count circuit generates a base intensity histogram for the background image from a supplied background image, and the base intensity histogram is supplied to another input terminal of the adder, and
wherein an output from the adder controls a gamma correction characteristic of the specific color expansion circuit.

5. The liquid crystal driving device according to claim 4,
further including a backlight processing circuit and a backlight controller,
wherein the backlight controller generates a backlight drive signal to be supplied to a backlight in response to data from the backlight processing circuit,
wherein, when the liquid crystal controller supplies low-intensity image data to the liquid crystal display panel, the backlight processing circuit decreases luminescence intensity of the backlight and the specific color expansion circuit intensifies a gradation of the low-intensity image data to improve contrast of the liquid crystal display panel,
wherein the backlight processing circuit generates a threshold gradation level of a specified occurrence rate with reference to a maximum intensity value for the image data based on the base intensity histogram created by the base histogram count circuit,
wherein the threshold gradation level generated from the backlight processing circuit is supplied to the specific color expansion circuit, and the specific color expansion circuit uses a specified stretch factor to intensify a gradation of the image data having a lower intensity than the threshold gradation level, and
wherein the specific color expansion circuit uses another stretch factor smaller than the specified stretch factor to intensify a gradation of the image data having an intensity higher than the threshold gradation level.

6. The liquid crystal driving device according to claim 5,
wherein the backlight processing circuit includes a second weight circuit, a second adder, and an operation circuit,
wherein the second weight circuit uses a second variable weight magnification to perform a second weight calculation on the specific color intensity histogram generated by the specific color intensity histogram count circuit, a result of the second weight calculation from the second weight circuit is supplied to one input terminal of the second adder, and a value for the second variable weight magnification is determined in proportion to the image input signal having the specific color,
wherein the base intensity histogram generated from the base histogram count circuit is supplied to another input terminal of the second adder, and
wherein the calculation circuit generates the threshold gradation level based on an output from the second adder.

7. The liquid crystal driving device according to claim 1,
wherein the liquid crystal driving device is integrated as a semiconductor integrated circuit chip.

8. The liquid crystal driving device according to claim 1,
wherein the specific color expansion circuit generates an image output signal that intensifies a gradation of an image input signal having flesh color as the image input signal of the specific color.

9. A liquid crystal driving device comprising:
a display data processing circuit;
a liquid crystal controller;
a backlight data processing circuit; and
a backlight controller,
wherein the display data processing circuit generates display data to be supplied to the liquid crystal controller, and the liquid crystal controller generates a liquid crystal drive signal to be supplied to a liquid crystal display panel in response to the display data,
wherein the display data processing circuit includes a base histogram count circuit that generates a base intensity histogram for the background image from a supplied background image,
wherein the backlight data processing circuit generates backlight data to be supplied to the backlight controller, and the backlight controller generates a backlight drive signal to be supplied to a backlight in response to the backlight data,
wherein, when the liquid crystal controller supplies low-intensity image data to the liquid crystal display panel, the backlight processing circuit decreases luminescence intensity of the backlight and the display data processing circuit intensifies a gradation of the low-intensity image data, to improve contrast of the liquid crystal display panel,
wherein the backlight processing circuit generates a threshold gradation level of a specified occurrence rate with reference to a maximum intensity value for the image data based on the base intensity histogram created by the base histogram count circuit,
wherein the threshold gradation level generated from the backlight processing circuit is supplied to the display data processing circuit, and the display data processing circuit uses a specified stretch factor to intensify a gradation of the image data having a lower intensity than the threshold gradation level, and
wherein the display data processing circuit uses another stretch factor smaller than the specified stretch factor to intensify a gradation of the image data having an intensity higher than the threshold gradation level.

10. The liquid crystal driving device according to claim 9,
wherein the display data processing circuit includes a specific color expansion circuit that generates an image output signal whose output gradation is intensified by a specified factor from an input gradation of an image input signal corresponding to a low-intensity specific color having a specified hue,
wherein, when the image input signal corresponding to the specific color indicates a high intensity, the specific color expansion circuit generates an image output signal whose output gradation is intensified by another factor smaller than the specified factor from the high-intensity image input signal, and
wherein the image output signal generated by the specific color expansion circuit is supplied as display data to the liquid crystal controller.

11. The liquid crystal driving device according to claim 9,
wherein the liquid crystal driving device is integrated as a semiconductor integrated circuit chip.
